(19) United States
(12) Patent Application Publication
(10) Pub. No.: US 2022/0010092 A1
(43) Pub. Date: Jan. 13, 2022

(54) ANTIBACTERIAL FILM

(71) Applicant: SKCS Co., Ltd., Gwangju-si (KR)

(72) Inventors: Hee Dong SON, Gwangju-si (KR); Su Yeong LEE, Gwangju-si (KR); Kyung Jin CHO, Gwangju-si (KR)

(73) Assignee: SKCS Co., Ltd.

(21) Appl. No.: 17/326,828

(22) Filed: May 21, 2021

(30) Foreign Application Priority Data
Jul. 13, 2020 (KR) 10-2020-0085899

(51) Int. Cl. C08K 3/015; B32B 7/06; B32B 7/12; B32B 27/18; B32B 27/40; C08J 7/04; C08K 3/08; C08K 5/54

(52) U.S. Cl. CPC C08K 3/015; B32B 7/06; B32B 7/12; C08K 5/54; B32B 27/40; C08J 7/0427; C08K 3/08; B32B 27/18

(57) ABSTRACT

Proposed is an antibacterial film. An antibacterial film according to an embodiment of the present disclosure includes: an antibacterial layer made of a composition including an acrylate-based UV resin, a silver nano-antibacterial agent, and a silicone-based leveling agent for improving surface smoothness; a base layer located under the antibacterial layer; an adhesive layer located under the base layer; and a release film located under the adhesive layer, wherein the composition for forming the antibacterial layer includes the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

### CROSS REFERENCE TO RELATED APPLICATION

The present application claims priority to Korean Patent Application No. 10-2020-0085899, filed Jul. 13, 2020, the entire contents of which is incorporated herein for all purposes by this reference.

### BACKGROUND OF THE INVENTION

### Field of the Invention

The present disclosure relates generally to an antibacterial film and, more particularly, to an antibacterial film having high surface smoothness without experiencing a deterioration in its antibacterial power.

### Description of the Related Art

Viral diseases occur around the world on a regular basis. Recently, the coronavirus has caused infections in the respiratory and digestive systems in humans. The coronavirus easily spreads among people by mucosal transmission or droplet transmission. Therefore, products with antibacterial functions are being developed to block infections caused by viruses and various bacteria.

More than 90% of products with antibacterial functions are being developed as protective film-type products with a function to prevent viruses and bacteria infecting public transportation facilities such as trains, subways, buses, etc. and multi-use facilities such as station/airport ticket machines, elevators, etc., where surfaces are exposed to frequent contact with human hands.

Antibacterial products are made of materials with high sterilizing and antibacterial power, helping to prevent infectious diseases.

Materials with high antibacterial power include silver (Ag), copper (Cu), gold (Au), lead (Pt), and nickel (Ni), and among these materials, silver is the material with the highest sterilizing power.

In particular, when converted into a nano-state using nanotechnology, silver has a strong antibacterial and sterilizing mechanism, and according to research reports, can sterilize 650 kinds of bacteria and viruses, and exhibit very excellent effects on fungi. These silver nanoparticles have a relatively wide surface area as their sizes become smaller, so that the antibacterial/sterilizing power becomes more excellent. Based on current experimental data, it is reported that the silver nanoparticles are 99.9% effective at sterilizing Escherichia coli, Staphylococcus aureus, Salmonella, Vibrio, Shigella, pneumococcal, typhoid, and methicillin-resistant Staphylococcus aureus (MRSA), which is most resistant to antibiotics.

These silver nanoparticles have dozens of times stronger sterilizing power than conventional chlorine-based materials, but are completely harmless to the human body, and thus have recently been expected as a useful therapeutic agent for various types of inflammation. Also, by their application to antibacterial deodorant processing, various functional products containing silver nanoparticles are being released.

In particular, there is a growing need for an antibacterial film containing a silver nanomaterial. The antibacterial film containing such a silver nanomaterial has to be manufactured with high antibacterial power without experiencing a deterioration in its surface smoothness.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and an objective of the present disclosure is to provide an antibacterial film having high surface smoothness without experiencing a deterioration in its antibacterial power, by including a silicone-based leveling agent for improving surface smoothness.

In order to achieve the above objective, according to one aspect of the present disclosure, there is provided an antibacterial film, including: an antibacterial layer made of a composition including an acrylate-based UV resin, a silver nano-antibacterial agent, and a silicone-based leveling agent for improving surface smoothness; a base layer located under the antibacterial layer; an adhesive layer located under the base layer; and a release film located under the adhesive layer, wherein the composition for forming the antibacterial layer may include the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

The composition for forming the antibacterial layer may include the silver nano-antibacterial agent in an amount from 0.10% by weight to 0.20% by weight, based on 100% by weight of the entire composition.

When a dry thickness of the antibacterial layer is 3 urn, the composition for forming the antibacterial layer may include the silver nano-antibacterial agent in an amount from 30 PPM to 60 PPM.

The antibacterial film may further include: a logo layer located between the base layer and the adhesive layer and made of a sheet or fabric on which a logo is printed.

According to another aspect of the present disclosure, there is provided an antibacterial film, including: an antibacterial layer made of a composition including an acrylate-based UV resin, a silver nano-antibacterial agent, and a silicone-based leveling agent for improving surface smoothness; a base layer located under the antibacterial layer; a first adhesive layer located under the base layer; an image layer located under the first adhesive layer; a sheet layer located under the image layer, and allowing printing of the image layer thereon; a second adhesive layer located under the sheet layer; and a release film located under the second adhesive layer, wherein the composition for forming the antibacterial layer may include the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

According to still another aspect of the present disclosure, there is provided an antibacterial film, including: an antibacterial layer made of a composition including an acrylate-based UV resin, a silver nano-antibacterial agent, and a silicone-based leveling agent for improving surface smoothness; a first base layer located under the antibacterial layer; a bonding layer located under the first base layer; a second base layer located under the bonding layer; an adhesive layer located under the second base layer; and a release film located under the adhesive layer, wherein the composition for forming the antibacterial layer may include the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

The composition for forming the antibacterial layer may include the silver nano-antibacterial agent in an amount from 0.10% by weight to 0.20% by weight, based on 100% by weight of the entire composition.

When a dry thickness of the antibacterial layer is 3 urn, the composition for forming the antibacterial layer may include the silver nano-antibacterial agent in an amount from 30 PPM to 60 PPM.

The first base layer and the second base layer may be made of polyethylene terephthalate (PET) or polyurethane.

According to embodiments of the present disclosure, it is possible to realize an antibacterial film having high surface smoothness without experiencing a deterioration in its antibacterial power, by including a silicone-based leveling agent for improving surface smoothness.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating the structure of an antibacterial film according to embodiments of the present disclosure;

FIG. 2 is a view illustrating the structure of an antibacterial film according to the embodiments of the present disclosure;

FIG. 3 is a view illustrating the structure of an antibacterial film according to the embodiments of the present disclosure;

FIG. 4 is a view illustrating the structure of an antibacterial film according to the embodiments of the present disclosure; and

FIG. 5 is a view illustrating a method of manufacturing an antibacterial film according to the embodiments of the present disclosure.

### DETAILED DESCRIPTION OF THE INVENTION

Hereinafter, exemplary embodiments of the present disclosure will be described in detail with reference to the drawings. It is noted that the same reference numerals designate the same constituent elements throughout the description of the drawings. In describing the present disclosure, if it is determined that the detailed description of a related known function or construction obfuscates the scope of the present disclosure unnecessarily ambiguous, the detailed description thereof will be omitted.

It will be understood that, although the terms first, second, A, B, (a), (b), etc. may be used herein to describe various elements of the present disclosure, these terms are only used to distinguish one element from another element and essential, order, or sequence of corresponding elements are not limited by these terms. It will be understood that when one element is referred to as being “connected to”, “coupled to”, or “linked to” another element, one element may be “connected to”, “coupled to”, or “linked to” another element via a further element although one element may be directly connected to or directly linked to another element.

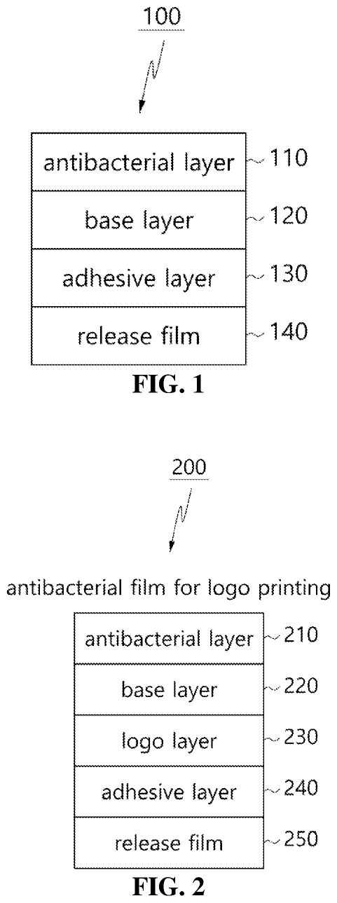

FIG. 1 is a view illustrating the structure of an antibacterial film according to embodiments of the present disclosure.

Referring to FIG. 1, an antibacterial film 100 according to a first embodiment of the present disclosure may include an antibacterial layer 110, a base layer 120, an adhesive layer 130, and a release film 140.

The antibacterial layer 110 may be formed on the base layer 120 and may be exposed to outside. The antibacterial layer 110 may include a silver nanomaterial. The silver nanomaterial may be obtained by pulverizing a material such as silver nitrate (AgNO₃) and silver sulfate (Ag₂SO₄) into nanoscale sizes.

The antibacterial layer 110 may have to be resistant to scratches because it is a part that may be exposed to outside and thus may have contact with people or an external object. Therefore, according to the embodiments of the present disclosure, the antibacterial layer 110 may be made of a material prepared according to a blending ratio for preventing scratches, on the base layer 120. The antibacterial layer 110 may include an acrylate-based UV resin, a silver nano-antibacterial agent, and a silicone-based leveling agent. That is, a composition for forming the antibacterial layer 110 may include the acrylate-based UV resin, the silver nano-antibacterial agent, and the silicone-based leveling agent.

As the acrylate-based UV resin, a polyfunctional acrylate-based monomer or a polyfunctional urethane acrylate-based oligomer may be used. In addition, the acrylate-based UV resin may be a UV curable resin.

The silver nano-antibacterial agent may be prepared by pulverizing and dispersing a silver salt such as silver nitrate or silver sulfate into nanoscale sizes. In addition, the silver nano-antibacterial agent may have a form of a sol in which silver nanoparticles are dispersed in a liquid. The maximum size of the silver nanomaterial or silver nanoparticles is preferably equal to or less than 1 nm. As the size thereof increases, the silver nanoparticles may not be evenly covered on a surface of the base layer 120. In this case, antibacterial performance may be deteriorated.

Therefore, it is preferable that silver nanoparticles having a size of equal to or less than 1 nm are used so that a silver nano-component is evenly applied on the surface of the base layer 120. The composition for forming the antibacterial layer 110 may have to include equal to or greater than 0.1% by weight of the silver nano-antibacterial agent, based on 100% by weight of the entire composition. For example, based on a dry coating thickness of 3 the silver nano-material may have to be included in an amount of equal to or greater than 30 PPM.

Meanwhile, in order to improve smoothness of a coating surface of the antibacterial layer 110, it is essential to include a leveling agent. However, the inventors of the present disclosure have found that a fluorine-based leveling agent inhibits the antibacterial performance. According to the present disclosure, the composition of the antibacterial layer 110 may include the silicone-based leveling agent. For example, the composition of the antibacterial layer 110 may include the silicone-based leveling agent in an amount from 0.05% by weight to 0.5% by weight.

### Example 1

According to Example 1 of the present disclosure, a composition of an antibacterial layer 110 may include 99.79% by weight of an acrylate-based UV resin, 0.06% by weight of a silver nano-antibacterial agent, and 0.15% by weight of a silicone-based leveling agent, based on 100% by weight of the entire composition. The antibacterial layer 110 was prepared from the composition according to Example 1.

### Example 2

According to Example 2 of the present disclosure, a composition of an antibacterial layer 110 may include 99.75% by weight of an acrylate-based UV resin, 0.10% by weight of a silver nano-antibacterial agent, and 0.15% by weight of a silicone-based leveling agent, based on 100% by weight of the entire composition. The antibacterial layer 110 was prepared from the composition according to Example 2.

### Example 3

According to Example 3 of the present disclosure, a composition of an antibacterial layer 110 may include 99.72% by weight of an acrylate-based UV resin, 0.13% by weight of a silver nano-antibacterial agent, and 0.15% by weight of a silicone-based leveling agent, based on 100% by weight of the entire composition. The antibacterial layer 110 was prepared from the composition according to Example 3.

### Example 4

According to Example 4 of the present disclosure, a composition of an antibacterial layer 110 may include 99.65% by weight of an acrylate-based UV resin, 0.20% by weight of a silver nano-antibacterial agent, and 0.15% by weight of a silicone-based leveling agent, based on 100% by weight of the entire composition. The antibacterial layer 110 was prepared from the composition according to Example 4.

### Comparative Example 1

A composition of an antibacterial layer 110 may include 99.82% by weight of an acrylate-based UV resin, 0.03% by weight of a silver nano-antibacterial agent, 0.05% by weight of a silicone-based leveling agent, and 0.10% by weight of a fluorine-based leveling agent, based on 100% by weight of the entire composition. The antibacterial layer 110 was prepared from the composition.

### Comparative Example 2

Except for the use of 0.05% by weight of a silicone-based leveling agent and 0.10% by weight of a fluorine-based leveling agent in place of 0.15% by weight of the silicone-based leveling agent of Example 1, based on 100% by weight of the entire composition of an antibacterial layer 110, the antibacterial layer 110 was prepared in the same manner as in Example 1.

### Comparative Example 3

A composition of an antibacterial layer 110 may include 99.46% by weight of an acrylate-based UV resin, 0.39% by weight of a silver nano-antibacterial agent, and 0.15% by weight of a silicone-based leveling agent, based on 100% by weight of the entire composition. The antibacterial layer 110 was prepared from the composition.

### Comparative Example 4

A composition of an antibacterial layer 110 may include 99.33% by weight of an acrylate-based UV resin, 0.52% by weight of a silver nano-antibacterial agent, and 0.15% by weight of a silicone-based leveling agent, based on 100% by weight of the entire composition. The antibacterial layer 110 was prepared from the composition.

The above Examples 1 to 4 and Comparative Examples 1 to 4 are summarized in Table 1 below.

TABLE 1

| | Acrylate- | Silver nano- | | |
|---|---|---|---|---|
| Examples by | based | antibacterial | Silicon-based | Fluorine-based |
| formulation | UV resin | agent | leveling agent | leveling agent |
| Comparative | 99.82% | 0.03% | 0.05% | 0.10% |
| Example 1 | | | | |
| Comparative | 99.79% | 0.06% | 0.05% | 0.10% |
| Example 2 | | | | |
| Example 1 | 99.79% | 0.06% | 0.15% | — |
| Example 2 | 99.75% | 0.10% | 0.15% | — |
| Example 3 | 99.72% | 0.13% | 0.15% | — |
| Example 4 | 99.65% | 0.20% | 0.15% | — |
| Comparative | 99.46% | 0.39% | 0.15% | — |
| Example 3 | | | | |
| Comparative | 99.33% | 0.52% | 0.15% | — |
| Example 4 | | | | |

Results of testing antibacterial performance of Examples 1 to 4 and Comparative Examples 1 to 4 are illustrated in Table 2 below.

TABLE 2

| | Antibacterial performance results (standard JIS Z 2801) | | | |
|---|---|---|---|---|
| | | Staphylococcus | | |
| Results | Escherichia coli | aureus | Pneumococcal | Salmonella |
| Comparative Example 1 | <10% | <10% | — | — |
| Comparative Example 2 | <60% | <60% | — | — |
| Example 1 | >99.9% | 99.2-99.3% | >99.9% | >99.9% |
| Example 2 | >99.9% | >99.9% | >99.9% | >99.9% |
| Example 3 | >99.9% | >99.9% | >99.9% | >99.9% |
| Example 3 | >99.9% | >99.9% | >99.9% | >99.9% |
| Example 4 | >99.9% | >99.9% | >99.9% | >99.9% |
| Comparative Example 3 | >99.9% | >99.9% | >99.9% | >99.9% |
| Comparative Example 4 | >99.9% | >99.9% | >99.9% | >99.9% |

From the results in Table 2, it can be seen that the antibacterial performance varies depending on a surface leveling agent component. Specifically, it can be seen that when the amount of the silver nano-antibacterial agent is 0.06% by weight, the antibacterial performance is improved in the case of using a silicone-based component than in the case of using a fluorine-based component.

It is also can be seen that the antibacterial performance is improved when an antibacterial agent is included in an amount equal to or greater than a predetermined amount. For example, it can be seen that the antibacterial performance of the antibacterial layer 110 is improved when the silver nano-antibacterial agent is included in an amount of equal to or greater than 0.06% by weight, based on 100% by weight of the entire composition. In addition, as in Examples 2, 3, and 4, in order to fully implement the antibacterial performance (equal to or greater than 99.9%) against a number of viruses and bacteria, it is preferable that the silver nano antibacterial agent is included in an amount of equal to or greater than 0.1% by weight.

Results of converting amounts of antibacterial agents of Examples 1 to 4 and Comparative Examples 1 and 2 into PPM units based on dry thickness 3 μm of the antibacterial layer 110 are illustrated in Table 3 below.

TABLE 3

| | Silver nano-antibacterial agent | | |
|---|---|---|---|
| | Compared to 100% by weight | Based on dry | |
| Classification | of the entire composition | thickness of 3 um | |
| Comparative | 0.03% | 9 | PPM |
| Example 1 | | | |
| Comparative | 0.06% | 18 | PPM |
| Example 2 | | | |
| Example 1 | 0.06% | 18 | PPM |
| Example 2 | 0.10% | 30 | PPM |
| Example 3 | 0.13% | 39 | PPM |
| Example 4 | 0.20% | 60 | PPM |
| Comparative | 0.39% | 117 | PPM |
| Example 3 | | | |
| Comparative | 0.52% | 156 | PPM |
| Example 4 | | | |

Meanwhile, although the silver nano-antibacterial agent is preferably included in an amount of equal to or greater than 0.10% by weight, based on 100% by weight of the entire composition of the antibacterial layer 110, when the amount thereof included in the composition of the antibacterial layer 110 is equal to or greater than a predetermined amount, surface properties of the antibacterial layer 110 are changed. Referring to Table 4 below, as in Example 3 and Example 4, the amount of the silver nano-antibacterial agent is preferably in the range from equal to or greater than 0.10% by weight to equal to or less than 0.20% by weight. That is, it is preferable that the composition for preparing the antibacterial layer 110 includes the silver nano-antibacterial agent in an amount ranging from equal to or greater than 0.10% by weight to equal to or less than 0.20% by weight.

That is, referring to Comparative Example 3 and Comparative Example 4, based on 100% by weight of the entire composition of the antibacterial layer 110, in Comparative Example 3, 0.39% by weight of the silver nano-antibacterial agent is included, and in Comparative Example 4, 0.52% by weight of the silver nano-antibacterial agent is included. Comparative Example 3 and Comparative Example 4 were good in surface hardness, but not better in surface abrasion resistance than Examples 1 to 4 according to the present disclosure. For example, under experimental conditions using a 500 g load and steel wool for surface abrasion resistance, in Comparative Example 3, fine scratches occurred, and in Comparative Example 4, fine scratches occurred more than in Comparative Example 3.

As described above, as the amount of a silver nanomaterial increases, the amount of a UV resin capable of implementing surface hardness properties decreases relatively, which deteriorates the surface abrasion resistance, resulting in scratches. Therefore, it is very important to include an appropriate amount of the silver nanomaterial without impairing the surface hardness properties. That is, as the amount of the silver nanomaterial increases, antibacterial properties improve, but excessive inclusion thereof acts as a factor that inhibits the surface hardness properties. In addition, considering the cost aspect, it is important to design an appropriate amount range for the silver nanomaterial.

Therefore, in consideration of surface properties (surface hardness and surface abrasion resistance), it is preferable that the amount of the silver nano-antibacterial agent is equal to or less than 0.20% by weight, based on 100% by weight of the entire composition of the antibacterial layer 110. As described above, the inventors of the present disclosure concluded that an optimal amount range of the silver nano-antibacterial agent is from 0.10% by weight to 0.20% by weight, which is most suitable.

TABLE 4

| | Surface hardness and surface abrasion | |
|---|---|---|
| | resistance evaluation results | |
| | Surface hardness | Surface abrasion resistance |
| Results | (Pencil hardness: 500 g load) | (Steel wool: 500 g load) |
| Example 3 | 2H | No Scratch |
| Example 4 | 2H | No Scratch |
| Comparative | 2H | Good, but fine |
| Example 3 | | scratches occur |
| Comparative | 2H | More fine scratches occur |
| Example 4 | | (more than Comparative |
| | | Example 3) |

Referring back to FIG. 1, the base layer 120 may be located under the antibacterial layer 110. The base layer 120 may support the antibacterial layer 210.

The base layer 120 may occupy most of the thickness of the antibacterial film 100. The base layer 120 may have a thickness in the range from 23 to 250 μm. According to an embodiment, the base layer 120 may be made of a thin polyethylene terephthalate (PET) film having a thickness in the range from 23 to 250 μm. The base layer 120 may be formed by processing a transparent PET film to have a desired color or function through a specific process. According to another embodiment, the base layer 120 may be made of polyurethane. Here, due to the fact that polyurethane is a softer material than PET, the antibacterial film 100 may be prevented from experiencing a loosening phenomenon when attached to a predetermined object.

The adhesive layer 130 may be formed on a surface, for example, a lower surface of the base layer 120. The adhesive layer 130 may be formed on the lower surface of the base layer 120 to a thickness in the range from 10 to 30 The adhesive layer 130 may be made of an acrylic-based adhesive, and may serve to impart adhesive performance to a vehicle glass protective film to allow the vehicle glass protective film to be adhered to a window glass of a vehicle.

At this time, the acrylic-based adhesive preferably includes 100 parts by weight of an acrylic copolymer, 2.5 to 3.5 parts by weight of a curing agent, and 30 to 50 parts by weight of a solvent, wherein the solvent is preferably one selected from the group consisting of methyl ethyl ketone, toluene, and ethyl acetate.

When the thickness thereof is less than 10 the adhesive layer 130 may be difficult to exhibit adhesive performance to a portion where unevenness occurs when attached to an object, which may cause a loosening or peeling phenomenon of the antibacterial film 100. On the other hand, when the thickness thereof exceeds 30 μm, the adhesive layer 130 may not have a uniform thickness due to low smoothness without significantly improving the adhesive performance to the portion where the bending or unevenness occurs, and residues may be generated in the process of removing the antibacterial film 100 from the object.

The adhesive layer 130 may provide the antibacterial film 100 with adhesive force to allow the antibacterial film 100 to be attached to the object. The adhesive layer 130 may be protected by the release film 140. According to an embodiment, the release film 140 may be configured as a PET liner having a thickness in the range from 25 to 36 μm.

A user may attach the antibacterial film 100 to a desired object after removing the release film 140 of the antibacterial film 100.

FIG. 2 is a view illustrating the structure of an antibacterial film according to the embodiments of the present disclosure.

Referring to FIG. 2, an antibacterial film 200 according to a second embodiment of the present disclosure may be an antibacterial film for logo printing. On the antibacterial film 200, a corporate image or a logo such as letters may be printed.

The antibacterial film 200 for logo printing may include an antibacterial layer 210, a base layer 220, a logo layer 230, an adhesive layer 240, and a release film 250. The antibacterial layer 210, the base layer 220, the adhesive layer 240, and the release film 250 remain similar in configuration to the antibacterial layer 110, the base layer 120, the adhesive layer 130, and the release film 100 of the first embodiment, and thus a detailed description thereof will be omitted.

The logo layer 230 may be located between the base layer 220 and the adhesive layer 240. The logo layer 230 may be formed, for example, by printing a logo on a surface of the base layer 220, i.e., the surface on which the adhesive layer 240 is laminated. Alternatively, the logo layer 130 may be formed by interposing a sheet or fabric on which a logo or image is printed between the base layer 220 and the adhesive layer 240.

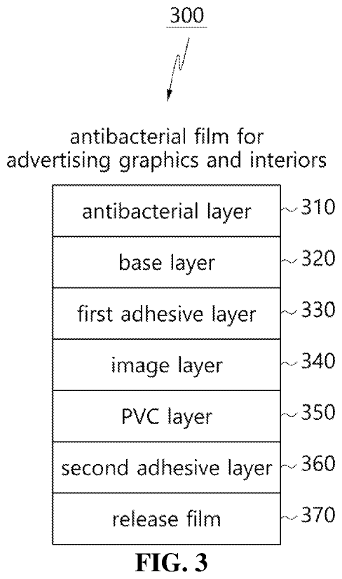

FIG. 3 is a view illustrating the structure of an antibacterial film according to the embodiments of the present disclosure.

Referring to FIG. 3, an antibacterial film 300 according to a third embodiment of the present disclosure may be an antibacterial film for advertising graphics and interiors.

The antibacterial film 300 for advertising graphics and interiors may include an antibacterial layer 310, a base layer 320, a first adhesive layer 330, an image layer 340, a PVC layer 350, and a second adhesive layer 360, and a release film 370.

The antibacterial layer 310, the base layer 320, and the release film 370 remain similar in configuration to the antibacterial layer 110, the base layer 120, and the release film 140 of the antibacterial film 100 of the first embodiment, and the first adhesive layer 330 and the second adhesive layer 360 remain similar in configuration to the adhesive layer 130 of the antibacterial film 100 of the first embodiment. Thus, a detailed description thereof will be omitted.

The image layer 340 may be formed by being directly printed on a fabric or sheet for advertisement promotion or design. In addition, the image layer 340 may be formed on a sheet made of poly vinyl chloride (PVC). The thickness of the PVC layer 350 that allows printing of the image layer 340 on the PVC layer 350 may be in the range from 70 to 95 μm. The image layer 340 may be attached to the first adhesive layer 330. The first adhesive layer 330 may allow the image layer 340 to be attached to the base layer 320. In addition, the second adhesive layer 360 may be formed under the PVC layer 350. The second adhesive layer 360 may be made of an acrylic-based adhesive, and may serve to impart adhesive performance to the antibacterial film 300 to allow the antibacterial film 300 to be adhered to an object.

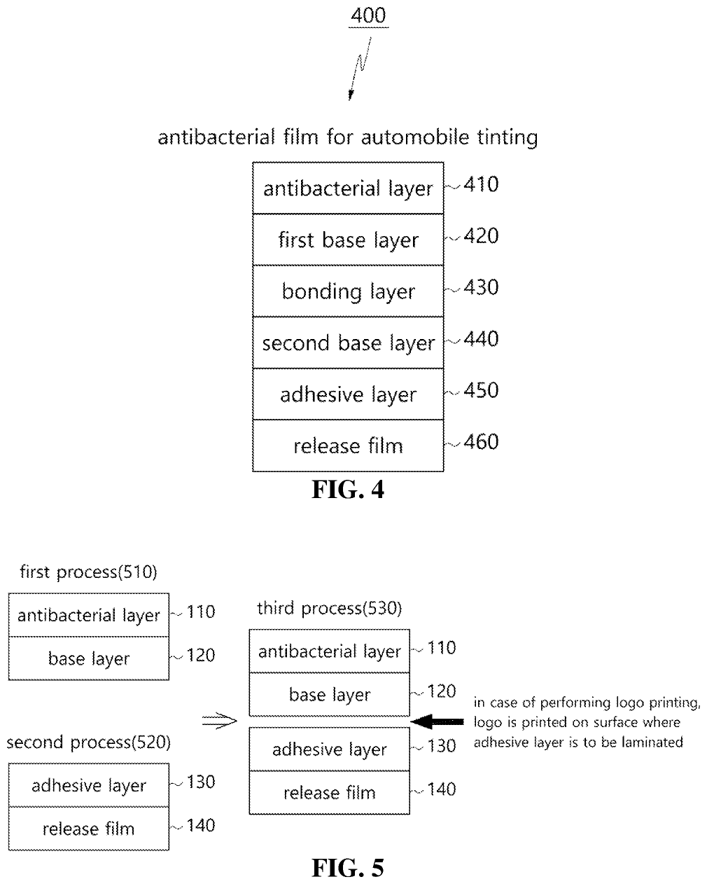

FIG. 4 is a view illustrating the structure of an antibacterial film according to the embodiments of the present disclosure.

Referring to FIG. 4, an antibacterial film 400 according to a fourth embodiment of the present disclosure may be an antibacterial film for automobile tinting.

The antibacterial film 400 for automobile tinting may include an antibacterial layer 410, a first base layer 420, a bonding layer 430, a second base layer 440, an adhesive layer 450, and a release film 460.

The antibacterial layer 410, the adhesive layer 450, and the release film 460 remain similar in configuration to the antibacterial layer 110, the adhesive layer 130, and the release film 140 of the antibacterial film 100 of the first embodiment, and thus a detailed description thereof will be omitted.

The antibacterial film 400 for automobile tinting may be attached to a window glass of a vehicle to prevent glare, block ultraviolet light and/or heat, prevent injuries caused by scattering of glass fragments when the glass breaks, protect privacy, and improve aesthetics of a vehicle body.

The antibacterial film 400 for automobile tinting may be configured such that the first base layer 420 is located under the antibacterial layer 410, the bonding layer 430 is located under the first base layer 420, and the second base layer 440 is located under the second base layer 440 with the bonding layer 430 interposed therebetween.

The first base layer 420 may be made of polyethylene terephthalate (PET) or polyurethane. The second base layer 440 may be formed under the bonding layer 430 and may support the antibacterial film 400 for automobile tinting in conjunction with the first base layer 420.

When made of polyurethane, the first base layer 420 may have an elongation of equal to or greater than 90% and a transmittance of equal to or greater than 90%. The first base layer 420 may have a thickness in the range from 23 to 36 μm. In addition, the first base layer 420 may have a shock absorbing function.

The bonding layer 430 may allow the first base layer 420 to be adhered to the second base layer 440. The bonding layer 430 may be a heat shielding and multifunctional adhesive. The bonding layer 430 may have a thickness smaller than that of each of the first base layer 420 and the second base layer 440 so as not to increase resilience of the antibacterial film 400 for automobile tinting.

The second base layer 440 may be a layer located closest to the window glass of the vehicle when attached to the window glass to which the antibacterial film 400 for automobile tinting is attached, and may be made of polyethylene terephthalate (PET) or polyurethane. The second base layer 440 may be formed under the bonding layer 430 and supports the antibacterial film 400 for automobile tinting in conjunction with the first base layer 420.

When made of polyurethane, the second base layer 440 may have an elongation of equal to or greater than 150% and a transmittance of equal to or greater than 90%. The second base layer 440 may have a thickness of about 12 μm when made of PET, and may have a thickness in the range from 50 to 75 μm when made of polyurethane. In addition, when made of polyurethane, the second base layer 440 may have a shock absorbing function, and may facilitate stretching of the antibacterial film 400 for automobile tinting, thereby increasing adhesion thereof to a rounding surface of the window glass of the vehicle.

In addition, the adhesive layer 450 may be made of a material having a UV blocking function to allow the antibacterial film 400 for automobile tinting to block ultraviolet light. When the antibacterial film 400 for automobile tinting is attached to the window glass of the vehicle, the adhesive layer 450 may be attached to the window glass after removing the release film 460.

FIG. 5 is a view illustrating a method of manufacturing an antibacterial film according to the embodiments of the present disclosure.

In order to manufacture an antibacterial film 100, in step 510, an antibacterial layer 110 may be formed by laminating or coating an antibacterial agent material solution on a surface of a base layer 120 made of a PET film. The antibacterial layer 110 may be formed by a micro-gravure coating method with the use of hot air drying and a UV curing device.

In step 520, an adhesive layer 130 may be formed by laminating or coating an adhesive to a thickness in the range from 25 to 36 μm on a PET liner, which is a release film 140, having a thickness in the range from 25 to 36 μm. Step 520 may be performed by a comma or die coating method with the use of hot air drying.

In step 530, the base layer 120 may be adhered to the adhesive layer 130 formed on the release film 140 to manufacture the antibacterial film 100.

The above description is only to describe the technical spirit of the present disclosure. Those skilled in the art will appreciate that various modifications and applications are possible, without departing from the scope and spirit of the present disclosure as disclosed in the accompanying claims. The embodiments of the present disclosure are therefore to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. An antibacterial film, comprising:
an antibacterial layer made of a composition comprising an acrylate-based UV resin, a silver nano-antibacterial agent, and a silicone-based leveling agent for improving surface smoothness;
a base layer located under the antibacterial layer;
an adhesive layer located under the base layer; and
a release film located under the adhesive layer,
wherein the composition for forming the antibacterial layer comprises the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

2. The antibacterial film of claim 1, wherein the composition for forming the antibacterial layer comprises the silver nano-antibacterial agent in an amount from 0.10% by weight to 0.20% by weight, based on 100% by weight of the entire composition.

3. The antibacterial film of claim 2, wherein when a dry thickness of the antibacterial layer is 3 um, the composition for forming the antibacterial layer comprises the silver nano-antibacterial agent in an amount from 30 PPM to 60 PPM.

4. The antibacterial film of claim 2, further comprising:
a logo layer located between the base layer and the adhesive layer and made of a sheet or fabric on which a logo is printed.

5. An antibacterial film, comprising:
an antibacterial layer made of a composition comprising an acrylate-based UV resin, a silver nano-antibacterial agent, and a silicone-based leveling agent for improving surface smoothness;
a base layer located under the antibacterial layer;
a first adhesive layer located under the base layer;
an image layer located under the first adhesive layer;
a sheet layer located under the image layer, and allowing printing of the image layer thereon;
a second adhesive layer located under the sheet layer; and
a release film located under the second adhesive layer,
wherein the composition for forming the antibacterial layer comprises the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

6. An antibacterial film, comprising:
an antibacterial layer made of a composition comprising an acrylate-based UV resin, a silver nano-antibacterial agent, and a silicone-based leveling agent for improving surface smoothness;
a first base layer located under the antibacterial layer;
a bonding layer located under the first base layer;
a second base layer located under the bonding layer;
an adhesive layer located under the second base layer; and
a release film located under the adhesive layer,
wherein the composition for forming the antibacterial layer comprises the silver nano-antibacterial agent in an amount from equal to or greater than 0.06% by weight to equal to or less than 0.20% by weight and the silicone-based leveling agent in an amount of 0.15% by weight, based on 100% by weight of the entire composition.

7. The antibacterial film of claim 5, wherein the composition for forming the antibacterial layer comprises the silver nano-antibacterial agent in an amount from 0.10% by weight to 0.20% by weight, based on 100% by weight of the entire composition.

8. The antibacterial film of claim 5, wherein when a dry thickness of the antibacterial layer is 3 um, the composition for forming the antibacterial layer comprises the silver nano-antibacterial agent in an amount from 30 PPM to 60 PPM.

9. The antibacterial film of claim 6, wherein the first base layer and the second base layer are made of polyethylene terephthalate (PET) or polyurethane.

10. The antibacterial film of claim 6, wherein the composition for forming the antibacterial layer comprises the silver nano-antibacterial agent in an amount from 0.10% by weight to 0.20% by weight, based on 100% by weight of the entire composition.

11. The antibacterial film of claim 6, wherein when a dry thickness of the antibacterial layer is 3 um, the composition for forming the antibacterial layer comprises the silver nano-antibacterial agent in an amount from 30 PPM to 60 PPM.
